(19) United States
(12) Patent Application Publication
(10) Pub. No.: US 2026/0122013 A1
(43) Pub. Date: Apr. 30, 2026

(54) METHOD AND SYSTEM FOR GENERATING BRAND-SPECIFIC CONTENT USING ARTIFICIAL INTELLIGENCE

(71) Applicant: Clayton Durant, New York, NY (US)

(72) Inventor: Clayton Durant, New York, NY (US)

(73) Assignee: MWW Group, LLC, New York, NY (US)

(21) Appl. No.: 18/919,898

(22) Filed: Oct. 18, 2024

(51) Int. Cl. H04L 51/02; H04L 51/52

(52) U.S. Cl. CPC H04L 51/02; H04L 51/52

(57) ABSTRACT

In an embodiment, a method using artificial intelligence for generating brand-specific content is disclosed. The method is performed by at least one processor including hardware. The method includes gathering, by a workspace platform, first data and second data related to a brand across a plurality of application programming interface connections. The workspace platform is further configured to build an AI chatbot configured to generate desired output in response to a given prompt. The workspace platform is further configured to format the first data and second data according to input specifications for the AI chatbot and train the AI chatbot using the first data. The method further includes retrieving, by the AI chatbot, the second data in response to directions from the workspace platform. The AI chatbot is further configured to interpret the second data and generate output including brand-specific content in response to a given prompt from the workspace platform.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to the field of Artificial Intelligence (“AI”) and data analysis, and in particular, the application of Large Language Models (“LLMs”) for the development of tailored brand content to enhance relevance and engagement.

Social media marketing has become a crucial aspect of a company's marketing strategy. It offers numerous benefits that can help businesses grow and achieve success, including an opportunity to reach a wider audience and increase brand awareness. As of 2024, 5.07 billion people worldwide use social media, making it an excellent platform for businesses to connect with potential customers and improve customer engagement.

Although using social media enables cost-effective marketing, keeping up with the fast-paced media environment to consistently generate content is overwhelming, time-consuming, and often inefficient. Thus, there is a need for an improved method of developing tailored content that resonates with a business's audience to ultimately drive relevance and awareness. By leveraging the power of LLMs, companies may be able to process vast amounts of data to generate content for social media. This saves companies time and energy in efficiently connecting with their target audience, building strong relationships with customers, and ultimately driving growth and success. The present invention also enables companies to work around executive inaccessibility and radically cut down on approval times for clients.

### SUMMARY

In an embodiment, a method using artificial intelligence (“AI”) for generating brand-specific content is disclosed. The method is performed by at least one processor comprising hardware. The method comprises gathering, by a workspace platform, first data and second data related to a brand across a plurality of application programming interface (“API”) connections. The workspace platform is further configured to build an AI chatbot configured to generate desired output in response to a given prompt. The workspace platform is further configured to format the first data and second data according to input specifications for the AI chatbot and train the AI chatbot using the first data.

The method further comprises retrieving, by the AI chatbot, the second data in response to directions from the workspace platform. The AI chatbot is further configured to interpret the second data and generate output comprising brand-specific content in response to a given prompt from the workspace platform.

In an embodiment, the first data and second data comprise static and dynamic data related to a brand. The plurality of API connections may comprise one or more of websites, research tools, company blogs, RSS feeds, Muck Rack™, NewsWhip™, Meltwater™, and Google™ Trends. The first data and second data may be automatically gathered on a daily, weekly, or monthly basis.

In an embodiment, the first data and second data comprise one or more of FAQ sheets, social media posts, social media profiles, briefing books and messaging documents, press releases and press mentions, interviews, op-eds, blogs, podcasts, and webinars.

In an embodiment, the AI chatbot is further configured to receive feedback on the output from the workspace platform and refine the output according to the feedback. The feedback may comprise additional prompts from the workspace platform. In an embodiment, a generative AI model is configured to analyze a performance of the output on a social media platform according to predefined performance metrics.

In an embodiment, a system using AI for generating brand-specific content is disclosed. The system comprises a workspace platform that is configured to gather first data and second data related to a brand across a plurality of API connections. The workspace platform is further configured to build an AI chatbot configured to generate desired output in response to a given prompt. The workspace platform is further configured to format the first data and second data according to input specifications for the AI chatbot train the AI chatbot using the first data.

The AI chatbot is configured to retrieve the second data in response to directions from the workspace platform, interpret the second data, and generate output comprising brand-specific content in response to a given prompt from the workspace platform.

In an embodiment, non-transitory computer-readable media comprising program code that when executed by a programmable processor causes execution of a method using AI for generating brand-specific content is disclosed. The computer readable media comprises computer program code for gathering, by a workspace platform, first data and second data related to a brand across a plurality of API connections. The computer readable media further comprises computer program code for building, by the workspace platform, an AI chatbot configured to generate desired output in response to a given prompt, formatting the first data and second data according to input specifications for the AI chatbot, and training the AI chatbot using the first data.

The computer readable media further comprises computer program code for retrieving, by the AI chatbot, the second data in response to directions from the workspace platform, interpreting the second data, and generating output comprising brand-specific content in response to a given prompt from the workspace platform.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIGS. 1 and 2 are diagrams of a system according to an embodiment.

FIG. 3 is a flow diagram of an example process for generating brand-specific content using artificial intelligence according to an embodiment.

FIG. 4 is a flow diagram of an example process for building an AI chatbot according to an embodiment.

FIG. 5 is a table of an example custom data structure for input for an AI chatbot according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

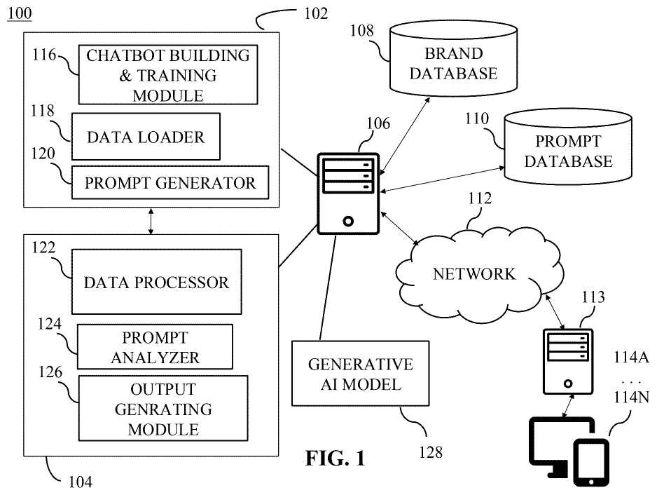

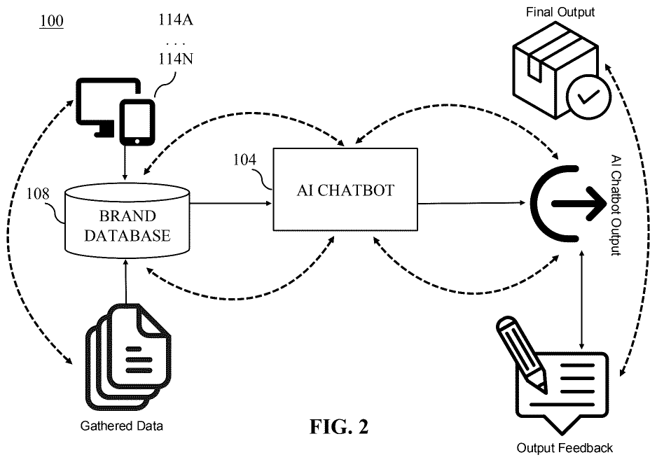

With reference to FIGS. 1 and 2, a system 100 is disclosed in accordance with embodiments of the invention that generates brand-specific content using artificial intelligence, specifically, LLMs such as OpenAI™. The advent of LLMs offers advanced capabilities for generating natural language explanations. These models can translate complex technical outputs into clear, accessible content that can be easily understood by marketers, business analysts, and social media audiences.

System 100 comprises a server 106 configured to store workspace platform 102, AI chatbot 104, and generative AI model 128 of the present invention. Network 112 is configured to connect server 106 with application programming interface (“API”) server 113 to access API connections 114A-114N. System 100 further comprises brand database 108 and prompt database 110.

System 100 integrates machine learning techniques and generative AI to enable brands and companies to build, train, interpret, and action their own AI chatbot with precision and clarity. Companies can use system 100 to predict and shape brand content from rapid-response situations to compelling thought leadership content including company news items, press releases, and other company content. System 100 enables companies to improve their performance on platforms such as LinkedIn™ and other social media.

In an embodiment, system 100 is configured to integrate with a company's existing corporate data systems. This allows system 100 to utilize a company's internal communication and performance metrics to increase content accuracy.

Workspace platform 102 comprises chatbot building and training module 116, data loader 118, and prompt generator 120. Data loader 118 gathers and integrates publicly available data related to a brand with internal brand database 108. In some embodiments, gathered data may also comprise “first-party data” acquired through a direct relationship with a given brand and stored in brand database 108. As such, system 100 allows companies to leverage their own first-party data to create content that is finely tuned to their specific audience and business needs.

Data loader 118 is connected via network 112 to API server 113 to access API connections 114A-114N to, for example, websites, research tools, company blogs, RSS feeds, Muck Rack™, NewsWhip™, Meltwater™, and Google™ Trends. In an embodiment, system 100 performs regular maintenance checks on API connections 114 to ensure data is being properly pulled into the brand database 108.

According to embodiments, data loader 118 is configured to gather static and dynamic data related to a given brand and may be configured to automatically gather data on a daily, weekly, or monthly basis. This enables rapid turnaround on response strategies that keep pace with the fast-moving media environment.

The gathered data may comprise relevant brand-specific coverage such as FAQ sheets, social media posts, social media profiles, briefing books and messaging documents, press releases and press mentions, interviews, op-eds, blogs, podcasts, and webinars. Such vast data ingestion provides a thorough understanding of the given brand and enables the creation of more targeted and effective content.

Chatbot building and training module 116 of workspace platform 102 is configured to build and train AI chatbot 104. Workspace platform 102 is configured to format the data gathered by data loader 118 according to input specifications for AI chatbot 104. For example, workspace platform 102 ensures that the gathered data is in a correct file format and meets defined parameters for processing by AI chatbot 104. In some embodiments, chatbot building and training module 116 utilizes first-party data, publicly available data, or a combination of the two from brand database 108 to train AI chatbot 104.

Prompt generator 120 of workspace platform 102 is configured to dynamically create and modify custom prompts that direct AI chatbot 104's focus during data analysis. For example, a company CEO may use prompt generator 120 to direct AI chatbot 104 to extract specific details that highlight a new product launch from the gathered data. In an embodiment, company-specific information, such as brand voice and style guidelines, are gleaned from gathered data or otherwise integrated to align the prompts with the company's communication strategy. This ensures that the prompts adhere to the company's tone, style, and messaging guidelines, thus maintaining a consistent and trustworthy voice. Generated prompts are stored in prompt database 110.

AI chatbot 104 utilizes OpenAI™ such as ChatGPT™ to generate desired output in response to a given prompt from workspace platform 102. AI chatbot 104 comprises data processor 122, prompt analyzer 124, and output generating module 126. Once trained, AI chatbot 104 is configured to retrieve data related to a given brand from brand database 108 in response to custom directions from workspace platform 102. The retrieved data comprises brand-relevant coverage that is fed into AI chatbot 104 for real-time interpretation and analysis by data processor 122. Prompt analyzer 124 receives and interprets one or more prompts from workspace platform 102 which direct the behavior of AI chatbot 104.

In response to the one or more prompts, AI chatbot 104 generates output comprising brand-specific content such as news items, press releases, social media posts and blog posts, as well as responses, perspectives and thought leadership content of company CEOs and other key executives. AI chatbot 104 is further configured to generate output based on company press releases such as concise summaries, highlights of the main points and key messages, quotes from company executives or stakeholders, and potential questions and appropriate responses. AI chatbot 104 is further configured to generate output based on press mentions or interviews of a company executive such as a comprehensive media profile, identification of recurring themes, key messages, and topics that the executive is known for or frequently discusses, a refined media strategy based on an understanding of how the executive is perceived and what aspects of their profile resonate with the media and audience, an assessment of the tone and sentiment of mentions, content for future media engagements, speeches, or marketing materials, and an analysis of the executive's media presence with that of competitors to identify strengths and areas for improvement.

The present invention empowers businesses to develop tailored content that resonates with their audience, ultimately driving business relevance and awareness. The present invention also enables companies to work around executive inaccessibility and radically cut down on approval times for clients.

System 100 continuously learns and adapts to the gathered data, thus refining AI chatbot 104 over time. In some embodiments, workspace platform 102 is configured to generate and provide feedback on the output to AI chatbot 104. According to an embodiment, the feedback comprises one or more additional prompts from prompt generator 120 designed to further tailor and refine the output content. The feedback may also comprise input from a system 100 administrator tasked with quality control. Continuous evaluation of the prompts and system performance ensures consistent quality and improvement while confirming that any gaps in knowledge or broader chatbot performance are addressed.

According to an embodiment, system 100 comprises generative AI model 128 which uses data analytics capabilities of generative AI to analyze and optimize the performance of the output according to predefined performance metrics. The performance metrics are designed to measure key factors such as engagement, visibility, impact, relevance, clarity, effectiveness, and distinctiveness. For example, generative AI model 128 may assign a performance score to an individual post or a company profile on LinkedIn™ based on a number of views, likes, shares, comments. Integrating disparate datasets for profile-wide metrics and individual post data provides a holistic view of performance. In an embodiment, the performance metrics are based on company Key Performance Indicators.

Generative AI model 128 provides precise predictive performance insights and ensures the AI chatbot 104 output stands out while aligning with the brand's intended message. According to an embodiment, generative AI model 128 uses API integrations to evaluate performance, optimize content strategies, and uncover new content opportunities. By analyzing vast amounts of data, generative AI model 128 can identify the key factors that drive engagement and visibility, enabling companies to tailor content to meet the evolving preferences of an executive's network.

In some embodiments, system 100 comprises logging and storage mechanisms to ensure the reproducibility and traceability. AI chatbot 104 configuration parameters, custom prompts, performance metrics, and outputs are logged, and the trained chatbot models are stored securely. This provides a historical context, ensuring continuity and consistency in output generation, as well as easy model versioning and future reference.

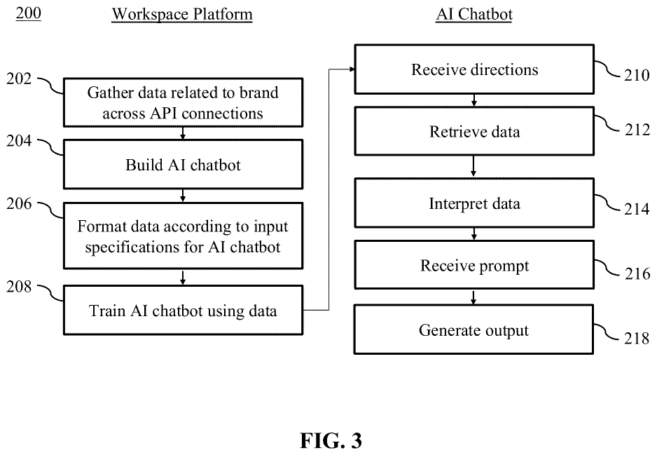

With reference to FIG. 3, a process 200 of using system 100 to generate brand-specific content in accordance with some embodiments will now be described. The process of FIG. 3 comprises steps 202 through 218 and is suitable for use in system 100 but is more generally applicable to other types of systems for content generation using artificial intelligence.

Steps 202 through 208 are performed by workspace platform 102. At step 202, as described above, data loader 118 gathers data related to a brand across one or more API connections 114A-114N via API server 113. The data may be publicly available or first-party data related to a brand. The data may be gathered from for example, websites, research tools, company blogs, RSS feeds, Muck Rack™, NewsWhip™, Meltwater™, and Google™ Trends and stored in brand database 108.

At step 204, chatbot building and training module 116 builds AI chatbot 104 to generate desired output in response to one or more prompts. At step 206, workspace platform 102 formats the gathered data according to input specifications for AI chatbot 104. For example, workspace platform 102 ensures that the gathered data is in a correct file format and meets defined parameters for processing by AI chatbot 104.

At step 208, workspace platform 102 trains AI chatbot 104 using the gathered, formatted data. In some embodiments, chatbot building and training module 116 utilizes first-party data, publicly available data, or a combination of the two from brand database 108 to train AI chatbot 104.

Steps 210 through 218 are performed by AI chatbot 104. At step 210, AI chatbot 104 receives directions from workspace platform 102 instructing AI chatbot 104 to, at step 212, retrieve data related to a given brand from brand database 108. At step 214, data processor 122 interprets the retrieved data.

At step 216, prompt analyzer 124 receives and analyzes one or more prompts from prompt generator 120 which direct AI chatbot 104's focus during data analysis. At step 218, in response to the one or more prompts, output generating module 126 utilizes OpenAI™ such as ChatGPT™ to generate desired output. The output comprises brand-specific content such as news items, press releases, and blog posts that can be shared, for example, across social media platforms, via email, or otherwise circulated to the company's target audience.

According to some embodiments, process 200 may comprise a feedback loop between steps 218 and 216, wherein AI chatbot 104 receives feedback on the output from workspace platform 102. In an embodiment, the feedback comprises additional prompts. AI chatbot 104 may then refine the output according to the feedback.

According to some embodiments, process 200 may comprise a feedback loop between steps 218 and 212, wherein AI chatbot 104 retrieves additional data related to the given brand from brand database 108, interprets the additional data, and generates output in response to one or more prompts. In an embodiment, system 100 stores metadata, AI chatbot 104, the prompts, and the output for future reference.

By integrating these components and following a meticulous process, system 100 ensures that the generated prompts and output are not only accurate and relevant but also trustworthy and aligned with the company's voice and strategic goals. Continuous evaluation and improvement processes as described herein ensure that system 100 evolves and adapts to changing needs and contexts. Metadata and traces are stored and continuously reviewed to create new updated prompts and output.

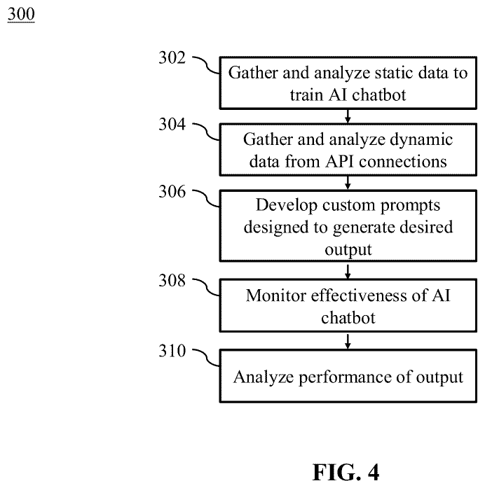

With reference to FIG. 4, a process 300 of using system 100 to build AI chatbot 104 in accordance with some embodiments will now be described. The process of FIG. 4 comprises steps 302 through 310 and is suitable for use in system 100 but is more generally applicable to other types of systems for building an AI chatbot.

At step 302, data loader 118 gathers static data including all relevant documents needed for chatbot building and training module 116 to train AI chatbot 104 on applicable knowledge. The gathered static data is stored in brand database 108 and analyzed by data processor 122. At step 304, once all relevant static documents have been collected, data loader 118 pulls dynamic data from all relevant ongoing data sources via API connections 114 on a daily, weekly, or monthly basis. The gathered dynamic data is stored in brand database 108 and analyzed by data processor 122.

At step 306, once all static and dynamic data have been gathered, prompt generator 120 develops custom prompts configured to generate desired output related to larger client deliverables. The custom prompts are stored in prompt database 110. Prompt analyzer 124 analyzes the custom prompts and output generating module 126 generates appropriate output in response to the analysis. The output comprises brand-specific content such as news items, press releases, and blog posts that can be shared, for example, across social media platforms, via email, or otherwise circulated to the company's target audience.

At step 308, workspace platform 102 monitors the effectiveness of AI chatbot 104, ensuring any gaps in knowledge or broader bot performance are addressed. At step 310, generative AI model 128 analyzes and optimizes the performance of the output according to predefined performance metrics. The output performance is analyzed for enhanced productivity, improved brand satisfaction, social copy, and contribution to achieving desired key performance indicators.

The particular processing operations and other system functionality described in conjunction with the flow diagrams of FIGS. 3 and 4 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the processes of FIGS. 3 and 4 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

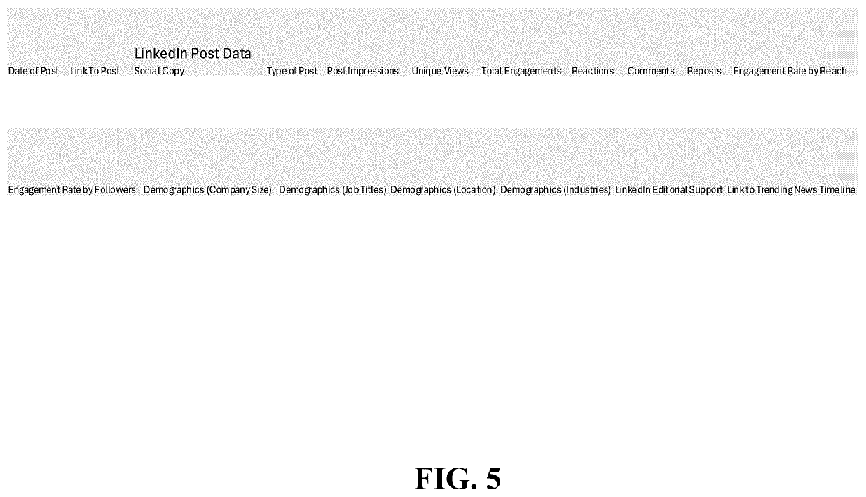

With reference to FIG. 5, a table illustrating a custom data structure for the gathered data being used as input for AI chatbot 104 is disclosed in accordance with embodiments of the invention. The gathered data may comprise relevant brand-specific coverage such as FAQ sheets, social media posts, social media profiles, briefing books and messaging documents, press releases and press mentions, interviews, op-eds, blogs, podcasts, and webinars. In some embodiments, chatbot building and training module 116 utilizes first-party data, publicly available data, or a combination of the two from brand database 108 to train AI chatbot 104. As the data continues to be input, AI chatbot 104 learns more about the brand's (or executive's) social voice. Generative AI model 128 analyzes the performance of the AI chatbot 104 output, including followership data such as the total number of followers and the number of followers gained by date. This enables insights into what metrics are, or are not, driving results, thus making the output much more relevant and valuable.

Workspace platform 102 is configured to format the data gathered by data loader 118 according to input specifications for AI chatbot 104. According to an embodiment, the gathered data comprises a social media post such as a LinkedIn® post. Workspace platform 102 formats the social media post according to the custom data structure shown in FIG. 5. The custom data structure includes the date of the post, a link to the post, the social copy (i.e., the text that accompanies the post), the type of post (e.g., short form), and the number of post impressions, unique views, total engagements, reactions, comments, and reposts. The custom data structure further includes a calculation of the engagement rate by reach (i.e., the number of post impressions divided by the number of total engagements, multiplied by 100) and a calculation of the engagement rate by followers (i.e., the number of total engagements divided by the total number of followers, multiplied by 100). The custom data structure further includes information on demographics, such as company size, job titles, location, and industries. The custom data structure further includes an indication of whether editorial support was used to construct the post (e.g., yes or no) and a link to a trending news timeline, if applicable.

FIGS. 1 through 5 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method using artificial intelligence (AI) for generating brand-specific content, the method performed by at least one processor comprising hardware, the method comprising:
gathering, by a workspace platform, first data and second data related to a brand across a plurality of application programming interface (API) connections;
building, by the workspace platform, an AI chatbot configured to generate desired output in response to a given prompt;
formatting, by the workspace platform, the first data and second data according to input specifications for the AI chatbot;
training, by the workspace platform, the AI chatbot using the first data;
retrieving, by the AI chatbot, the second data in response to directions from the workspace platform;
interpreting, by the AI chatbot, the second data; and
generating, by the AI chatbot, output comprising brand-specific content in response to a given prompt from the workspace platform.

2. The method of claim 1, wherein gathering first data and second data related to a brand comprises gathering static and dynamic first data and static and dynamic second data related to a brand.

3. The method of claim 1, wherein gathering first data and second data across a plurality of API connections comprises gathering first data and second data from one or more of websites, research tools, company blogs, RSS feeds, Muck Rack™, NewsWhip™, Meltwater™, and Google™ Trends.

4. The method of claim 1, wherein gathering first data and second data across a plurality of API connections comprises automatically gathering first data and second data on a daily, weekly, or monthly basis.

5. The method of claim 1, wherein gathering first data and second data related to a brand comprises gathering one or more of FAQ sheets, social media posts, social media profiles, briefing books and messaging documents, press releases and press mentions, interviews, op-eds, blogs, podcasts, and webinars.

6. The method of claim 1, the method further comprising:
receiving, by the AI chatbot, feedback on the output from the workspace platform; and
refining, by the AI chatbot, the output according to the feedback.

7. The method of claim 6, wherein receiving feedback from the workspace platform comprises receiving feedback comprising additional prompts.

8. The method of claim 1, the method further comprising analyzing, by a generative AI model, a performance of the output on a social media platform according to predefined performance metrics.

9. A system using artificial intelligence (AI) for generating brand-specific content, the system comprising:
a workspace platform configured to:
gather first data and second data related to a brand across a plurality of application programming interface (API) connections;
build an AI chatbot configured to generate desired output in response to a given prompt;
format the first data and second data according to input specifications for the AI chatbot; and
train the AI chatbot using the first data; and
the AI chatbot being configured to:
retrieve the second data in response to directions from the workspace platform;
interpret the second data; and
generate output comprising brand-specific content in response to a given prompt from the workspace platform.

10. The system of claim 9, wherein the first data and second data comprise static and dynamic data related to a brand.

11. The system of claim 9, wherein the plurality of API connections comprises one or more of websites, research tools, company blogs, RSS feeds, Muck Rack™, NewsWhip™, Meltwater™, and Google™ Trends.

12. The system of claim 9, wherein the first data and second data are automatically gathered on a daily, weekly, or monthly basis.

13. The system of claim 9, wherein the first data and second data comprise one or more of FAQ sheets, social media posts, social media profiles, briefing books and messaging documents, press releases and press mentions, interviews, op-eds, blogs, podcasts, and webinars.

14. The system of claim 9, the AI chatbot being further configured to:
receive feedback on the output from the workspace platform; and
refine the output according to the feedback.

15. The system of claim 14, wherein the feedback comprises additional prompts.

16. The system of claim 9, the system further comprising a generative AI model configured to analyze a performance of the output on a social media platform according to predefined performance metrics.

17. Non-transitory computer-readable media comprising program code that when executed by a programmable processor causes execution of a method using artificial intelligence (AI) for generating brand-specific content, the computer readable media comprising:
computer program code for gathering, by a workspace platform, first data and second data related to a brand across a plurality of application programming interface (API) connections;
computer program code for building, by the workspace platform, an AI chatbot configured to generate desired output in response to a given prompt;
computer program code for formatting, by the workspace platform, the first data and second data according to input specifications for the AI chatbot;
computer program code for training, by the workspace platform, the AI chatbot using the first data;
computer program code for retrieving, by the AI chatbot, the second data in response to directions from the workspace platform;
computer program code for interpreting, by the AI chatbot, the second data; and
computer program code for generating, by the AI chatbot, output comprising brand-specific content in response to a given prompt from the workspace platform.

18. The non-transitory computer-readable media of claim 17, wherein the first data and second data comprise static and dynamic data related to a brand.

19. The non-transitory computer-readable media of claim 17 further comprising computer program code for automatically gathering the first data and second data on a daily, weekly, or monthly basis.

20. The non-transitory computer-readable media of claim 17 further comprising computer program code for analyzing, by a generative AI model, a performance of the output on a social media platform according to predefined performance metrics.
